(19) United States
(12) Patent Application Publication
(10) Pub. No.: US 2005/0051972 A1
(43) Pub. Date: Mar. 10, 2005

(54) Constant velocity joint assembly and sealing boot

(76) Inventor: Shen-Ling Allen Wang, Northville, MI (US)

Correspondence Address: GKN DRIVELINE NORTH AMERICA, INC, 3300 UNIVERSITY DRIVE, AUBURN HILLS, MI, 48326, US

(21) Appl. No.: 10/655,445

(22) Filed: Sep. 4, 2003

(51) Int. Cl. F16J 3/00

(52) U.S. Cl. 277/634

(57) ABSTRACT

A joint sealing boot, comprising a first end affixable to a first joint member and a second end affixable to a second joint member, wherein at least one of the sealing boot ends is reinforced with a rigid support material.

### TECHNICAL FIELD

The present invention relates to an improved sealing solution for a propshaft joint boot.

### BACKGROUND ART

There are generally four (4) main types of automotive drive line systems. More specifically, there exists a full-time front wheel drive system, a full-time rear wheel drive system, a part-time four wheel drive system, and an all-wheel drive system. Most commonly, the systems are distinguished by the delivery of power to different combinations of drive wheels, i.e., front drive wheels, rear drive wheels or some combination thereof. In addition to delivering power to a particular combination of drive wheels, most drive systems permit the respectively driven wheels to rotate at different speeds. For example, the outside wheels may rotate faster than the inside drive wheels, and the front drive wheels normally rotate faster than the rear wheels.

Drive line systems also include one or more constant velocity universal joints (e.g. plunging tripod, plunging cross groove, high speed fixed joint, etc.) where transmission of a constant velocity rotary motion is desired or required. Such joints, and their operation, are well known to those skilled in the art. Accordingly, they will be discussed only briefly below.

A plunging tripod type constant velocity universal joint is characterized by the performance of end motion in the joint. Plunging tripod joints are currently the most widely used inboard (transmission side) joint in front wheel drive vehicles, and particularly in the propeller shafts found in rear wheel drive, all-wheel drive and four-wheel drive vehicles. Plunging tripod universal joints allow their respective interconnection shafts to change length during operation without the use of splines which provoke significant reaction forces thereby resulting in a source of vibration and noise.

Another common type of constant velocity universal joint is the plunging VL or “cross groove” type, which consists of an outer and inner race drivably connected through balls located in circumferentially spaced straight or helical grooves alternately inclined relative to a rotational axis. The balls are positioned in a constant velocity plane by an intersecting groove relationship and maintained in this plane by a cage located between the two races. The joint permits axial movement since the cage is not positionably engaged to either race. As those skilled in the art will recognize, the principal advantage of this type of joint is its ability to transmit constant velocity and simultaneously accommodate axial motion. Plunging VL constant velocity universal joints are currently used for high speed applications such as, for example, the propeller shafts found in rear wheel drive, all-wheel drive and four-wheel drive vehicles.

The high speed fixed joint (HSFJ) is another type of constant velocity joint well known in the art and used where transmission of high speed is required. High speed fixed joints allow articulation to an angle (no plunge) but can accommodate much higher angles than with a Cardan joint or other non-CV joints such as, for example, rubber couplings. There are generally three types of high speed fixed joints: (1) disk style that bolts to flanges; (2) monoblock style that is affixed to the tube as a center joint in multi-piece propshafts; and (3) plug-on monoblock that interfaces directly to the axle or T-case replacing the flange and bolts.

A typical driveline system incorporates one or more of the above joints in an all wheel drive or traditional four wheel drive system. In an all wheel drive system, such joints are used to connect a pair of propeller shafts (front and rear) (also called a propeller shaft assembly) to a power take off unit and a rear driveline module, respectively. These propeller shafts (“propshafts”) function to transfer torque to the rear axle in rear wheel and all wheel drive vehicles. Similarly, in a traditional four wheel drive system, such joints are used to connect the propeller shaft between a transfer case and the front axle.

Most constant velocity universal joints are sealed in order to retain grease inside the joint while keeping contaminants and foreign matter, such as dirt, water, and the like out of the joint. In order to achieve this protection, the constant velocity joint is usually enclosed at the open end of the outer race by a sealing boot made of rubber, thermoplastic or urethane. The opposite end of the outer race is sometimes formed by an enclosed dome known in the art as a “grease cap.” Such sealing and protection of the constant velocity joint is necessary because, once the inner chamber of the outer joint is partially filled and thus lubricated, it is generally lubricated for life. Many of the prior art constant velocity joints operate at very high temperatures and high operating angles. Those two features taken in conjunction with the high speed rotation of the joints may lead to premature failures, blow outs or ruptures of the boot. The boot in prior art joints tends to be a source of many failures and premature break downs of the constant velocity joint operating in the above stated conditions.

Therefore, there is a need in the art for an improved boot. There also is a need in the art for a reinforced boot that can operate and be more durable in the operating environment of the constant velocity joint. Furthermore, there is a need in the art for a boot that will ensure the joint chamber is properly and effectively sealed from ingress of contaminates and leakage of lubricating grease from the joint.

### DISCLOSURE OF THE INVENTION

It is an object of the present invention to provide a joint and shaft assembly having improved sealing means during high speed operation, high temperatures, and high operating angles.

It is another object of the present invention to provide a constant velocity joint boot that is more stable during high speed applications.

It is yet another object of the present invention to provide proper boot sealing in a joint for a plurality of boot environments and high operating temperatures.

In carrying out the above objects, there is provided a joint sealing boot having a first end affixable to a shaft and a second end affixable to a boot cover. At least one of the boot ends is reinforced with a substantially rigid support material to provide improved sealing means.

One advantage of the present invention is that the constant velocity joint has improved sealing means.

Another advantage of the present invention is the increased stability of a constant velocity joint at high speeds.

Yet another advantage of the present invention is the increased stiffness of the boot.

Still another advantage of the present invention is the use of a fabric to reinforce the boot.

Other objects, features and advantages of the present invention will become apparent from the subsequent description and the appended claims, taken in conjunction with the accompanying drawings.

### BRIEF DESCRIPTION OF THE DRAWINGS

FIG. 1 is a cross-sectional view of the sealing boot of the present invention shown affixed to a constant velocity joint.

FIG. 2 is an exploded perspective view of the sealing boot of FIG. 1 and an inner race of the constant velocity joint.

FIG. 3 is a cross sectional view of the constant velocity joint of FIGS. 1 and 2.

FIG. 4 is a top plan view of the sealing boot of the present invention.

FIG. 5 is a cross sectional view of the sealing boot of the present invention taken along line 5-5 of FIG. 4.

FIGS. 6-8 are enlarged partial cross sectional views of the sealing boot of the present invention illustrating the internally incorporated substantially rigid support material in further detail.

### BEST MODE FOR CARRYING OUT THE INVENTION

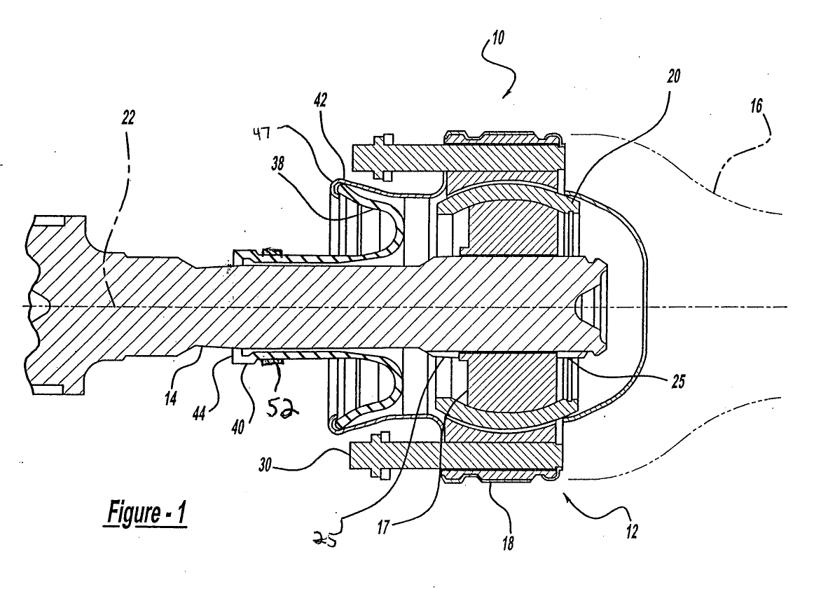

Referring to the figures, there is shown a constant velocity joint and shaft assembly 10 according to the invention. The assembly 10 includes a constant velocity joint 12 for transmitting torque between a first shaft 14 and another component such as a second shaft 16. One of the shafts 14 or 16 may be a drive shaft such as a propeller shaft. The joint 12 includes a first joint part such as an inner race 17, a second joint part such as an outer race 18, and a ball cage 20 disposed in an annular space between the races 17 and 18. While the joint 12 is configured to operate through a wide range of angles, FIG. 1 shows the races 17 and 18 and ball cage 20 aligned along a common central axis 22.

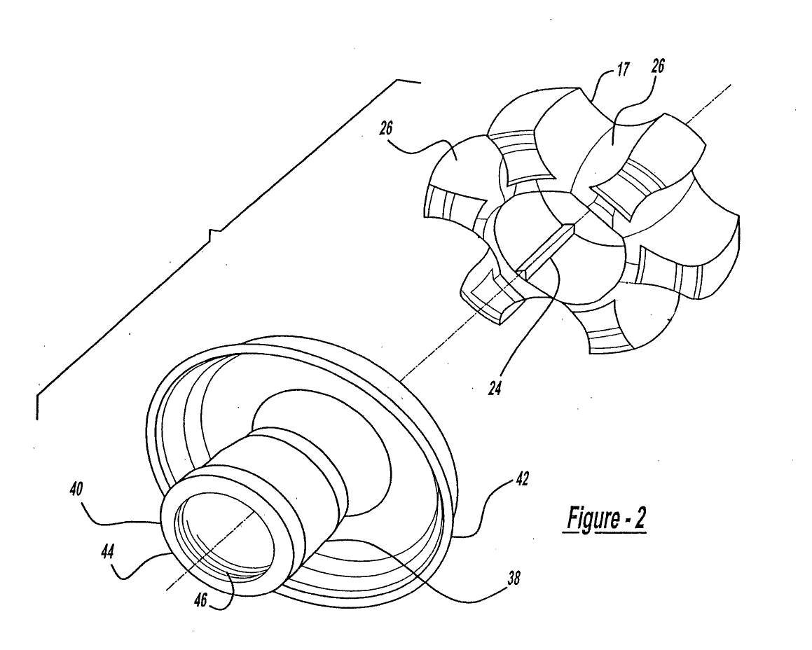

As shown more particularly in FIGS. 2-3, the inner race 17 is slidably connected to the first shaft 14 in any suitable manner. For example, the inner race 17 may be provided with a splined opening 24 that mates with a splined outer surface 25 of the first shaft 14. With such a configuration, the inner race 17 may rotate with the first shaft 14, and may also move axially along the first shaft 14. The inner race 17 also has a plurality of first tracks 26.

The outer race 18 is connected to the second shaft 16 in any suitable manner, such as with fasteners 30, welding, or any other known fastening means. Alternatively, the outer race 18 and the second shaft 16 may be formed as a single component. The outer race 18 includes a plurality of second tracks 31.

The ball cage 20 has a plurality of circumferentially distributed windows 34 for retaining a plurality of torque-transmitting balls 36. Each ball 36 is engageable with a pair of first and second tracks 26 and 31, respectively, for transmitting torque between the inner and outer races 17 and 18 respectively.

The boot 38 has first and second sections 40 and 42, respectively. The boot 38 preferably has a seal, such as a radially extending annular portion 44, that is configured to retain lubrication within the assembly 10. Preferably, but not necessarily, the annular portion 44 is provided with a plurality of annular ridges 46. The section of the boot 38 is held against the shaft 14 by a clamp or other fastener 52.

The second section of the boot 42 is connected directly or indirectly to the outer race 18. For example, the second end 42 may be connected to a boot cover or can 47 that is attached to the outer race 18 in any suitable manner. In one embodiment the can 47 is crimped around one edge of the boot 38.

The boot 38 may comprise any suitable material that is sufficiently flexible to allow the joint 12 to operate through a wide range of angles. Suitable materials include thermoplastic, rubber, silicone, plastic material and urethane, etc. Advantageously, thermoplastic, rubber and silicone also provide good sealing properties for the annular portion 44.

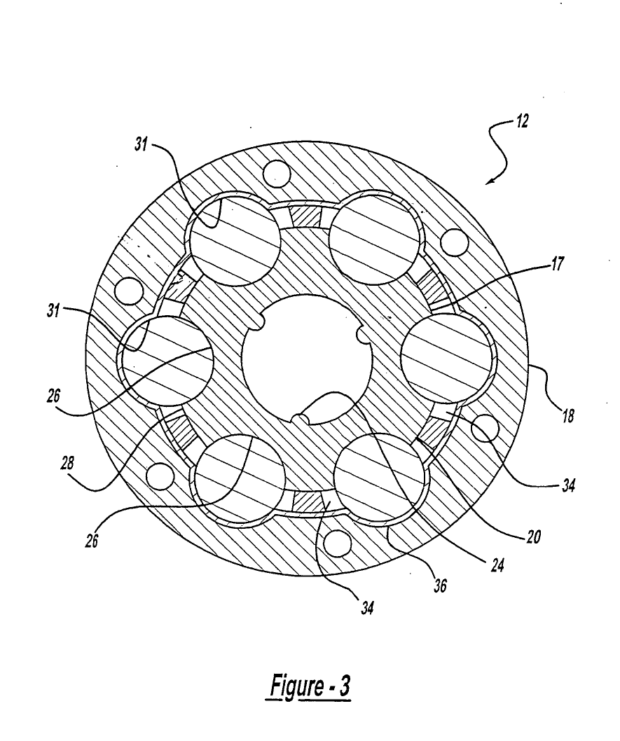

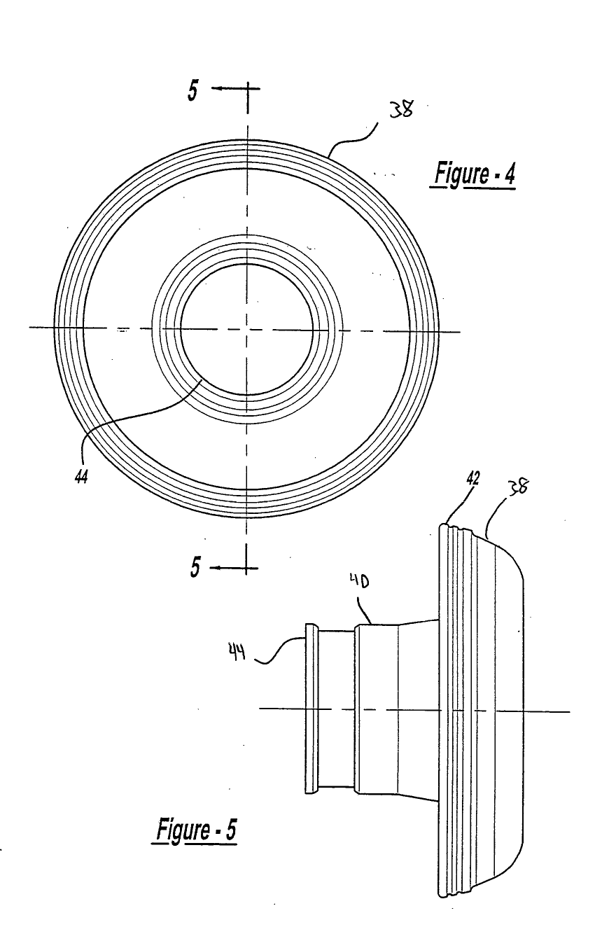

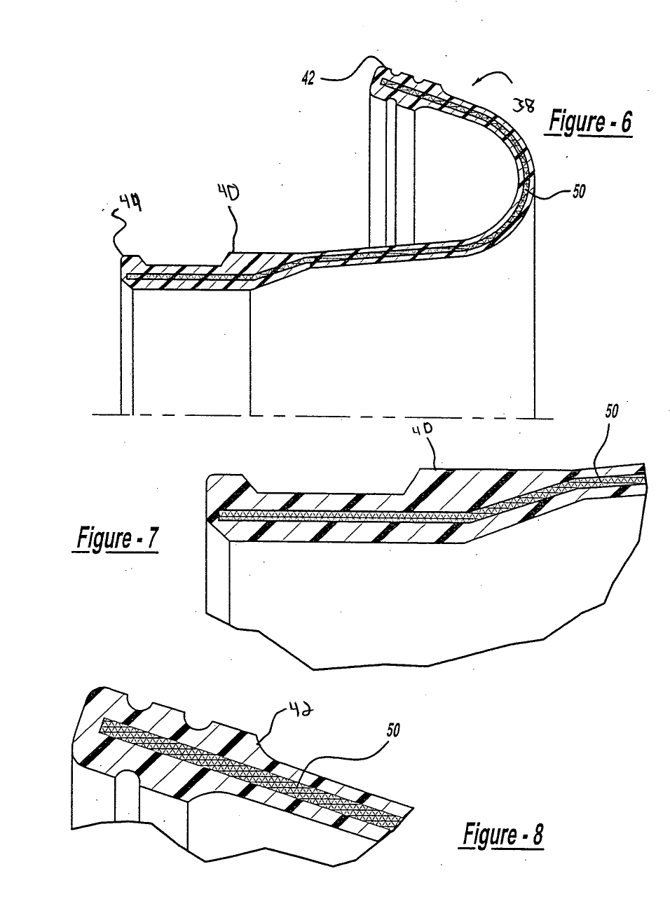

As shown in more detail in FIGS. 4-8, boot 38 and more particularly boot first and second ends 40 and 42, further include and are reinforced with a substantially rigid support layer 50. In one embodiment the layer 50 is a fabric. Layer 50 may, of course, comprise any suitable natural or synthetic material or combination thereof depending on the application and the desired result and may include, without limitation, HNBR, Vamac, FKM, FVMQ, etc. Layer 50 may also, depending on the application, comprise a contiguous sheet or, alternatively, may comprise a mesh or other collection of discrete pieces or functional parts.

Support layer 50 may be incorporated within boot 38 in any suitable manner, including, integral molding, deposition, adhesive, etc. In the embodiment shown the layer 50 is arranged between or sandwiched between layers of the flexible material of the boot 38. It is even contemplated that the layer 50 be arranged on either the inside, outside or both surfaces of the boot 38. In the preferred embodiment shown, contiguous layer 50 is arranged within boot 38 and extends substantially between ends 40 and 42. In this embodiment, layer 50 is also shown having a relative thickness substantially the same as that of the respective surrounding layers formed by boot 38. Incorporation of support layer 50 within boot 38 provides improved spin stability, improved durability and improved strength at high speeds, high angles and elevated temperatures. It is understood, however, that all or any desired portion of layer 50 may extend any desired distance between boot ends 40 and 42, even the entire length of boot 38. Similarly, layer 50 may have any suitable thickness depending on the application and the desired result.

In operation the boot 38 will be secured between the can 47 and the shaft 14. The connection between the boot 38 and the can 47 is generally accomplished by crimping the edge of the can 47 over the edge of the boot 38. The fabric reinforced boot 38 will stabilize the boot 38 during high speed operation. The fabric 50 will give the boot 38 high stiffness and strength which will allow the boot 38 to operate properly as a seal, etc., in high temperature and high operating angle environments. The new boot 38 of the present invention will allow for a more robust and reliable boot for a constant velocity joint 42.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A boot for use with a joint, said boot comprising:
a body;
a first end of said body having a generally tubular shape;
a second end of said body having an annular sealing lip;
an annular ridge arranged on said body; and
at least one end of said sealing boot ends is reinforced with a rigid support material, said rigid support material is arranged between layers of said body material.

2. The boot of claim 1, wherein said at least one end is internally reinforced.

3. The boot of claim 1, wherein said at least one end is reinforced with a high stiffness and high strength material.

4. The boot of claim 3 wherein said high stiffness and high strength material is a fabric.

5. The boot of claim 1 wherein said rigid support material is arranged between layers of a flexible material.

6. The boot of claim 5 wherein said flexible material is a thermoplastic.

7. The boot of claim 1 wherein said rigid support material extends from approximately said first end to said second end.

8. The boot of claim 1 wherein said rigid support material stabilizes the boot at high speeds.

9. A boot having high stability and superior sealing capability during high speed operation, high temperatures, and high operating angles for use on a joint, said boot comprising:
a body;
a first end of said body having a generally tubular shape;
a second end of said body having an annular sealing area;
an annular ridge on said body;
the sealing boot is comprised of a flexible material and at least one end having a high stiffness and high strength material encapsulated within said flexible material for providing the high stability and superior sealing.

10. The boot of claim 9 wherein said high stiffness and high strength material extends from approximately said first end to said second end.

11. The boot of claim 9 wherein said high stiffness and high strength material is arranged between a first and second layers of said flexible material.

12. The boot of claim 9 wherein said high stiffness and high strength material is a fabric.

13. A joint assembly, said assembly comprising:
a shaft;
a first joint part connected to said shaft;
a second joint part cooperable with said first joint part to transmit torque there between;
a plurality of balls arranged between said first joint part and said second joint part;
a boot having a first end contacting said shaft and a second end associated with said second joint part; and
wherein at least one of said boot ends is reinforced with a rigid support material.

14. The assembly of claim 13, wherein said at least one end is internally reinforced.

15. The assembly of claim 13, wherein said at lest one end is reinforced with a high stiffness and high strength material.

16. The boot of claim 15 wherein said high stiffness and high strength material is a fabric.

17. The boot of claim 13 wherein said rigid support material is arranged between layers of a flexible material.

18. The boot of claim 17 wherein said flexible material is a rubber.

19. The boot of claim 13 wherein said rigid support material extends from approximately said first end to said second end.

20. A joint assembly for use on a vehicle, said assembly comprising:
a shaft;
a first joint part connected to said shaft;
a second joint part cooperable with said first joint part to transmit torque there between;
a cage arranged between said first joint part and said second joint part;
a rubber boot having a first end contacting said shaft and a second end associated with said second joint part;
a boot cover having a first end and a second end, said first end of said boot cover affixable to said second joint part and said second end of said boot cover affixable to said second end of said boot; and
wherein at least one end of said boot ends is internally reinforced with a high stiffness and high strength fabric material so as to provide high stability and superior sealing capability during high speed operation, high temperatures, and high operation angles.
